(19) United States
(12) Patent Application Publication
(10) Pub. No.: US 2009/0320296 A1
(43) Pub. Date: Dec. 31, 2009

(54) HAIR TRIMMER BLADE UNIT

(75) Inventors: Kazuhiro MORISUGI, Inukami (JP); Makoto FUKUTANI, Hikone (JP); Jiro YOICHI, Nagahama (JP); Toshio IKUTA, Hikone (JP); Takashi KOZAI, Inukami (JP); Hiroyuki OKADA, Maibara (JP)

Correspondence Address: Workman Nydegger;1000 Eagle Gate Tower, 60 East South Temple, Salt Lake City, UT, 84111, US

(73) Assignee: PANASONIC ELECTRIC WORKS, CO., LTD., Osaka (JP)

(21) Appl. No.: 12/488,738

(22) Filed: Jun. 22, 2009

(30) Foreign Application Priority Data
Jun. 25, 2008 (JP) 2008-165546

(51) Int. Cl. B26B 19/02; B26B 19/28; B26B 19/00

(52) U.S. Cl. 30/43.92; 30/45; 30/233.5

(57) ABSTRACT

A hair trimmer blade unit includes a stationary blade and a movable blade, which includes movable blade pieces. Each movable blade piece includes a basal blade edge portion and a distal catch portion. The basal blade edge portion extends along a line inclined so that as the distal end of the movable blade piece become closer, the distance from the adjacent movable blade piece increases. The distal catch portion extends toward the adjacent movable blade piece from the line. The blade edge of each movable blade piece includes a saw-toothed portion formed so that as the distal end of the corresponding movable blade piece becomes closer, the distance from the adjacent movable blade pieces decreases in plural steps.

### CROSS-REFERENCE TO RELATED APPLICATIONS

This application claims the benefit of Japanese Patent Application No. 2008-165546, filed on Jun. 25, 2008, the entire contents of which are incorporated herein by reference.

### TECHNICAL FIELD

The present invention relates to a hair trimmer blade unit which reciprocates a movable blade relative to a stationary blade and relates to an electric hair trimmer.

An electric hair trimmer blade unit or the like includes a comb-shaped stationary blade and a comb-shaped movable blade. The stationary blade includes a plurality of stationary blade pieces. The movable blade includes a plurality of movable blade pieces overlapped with the stationary blade pieces. The movable blade reciprocates relative to the stationary blade to cut hair.

Japanese Laid-Open Patent Publication No. 2008-80111 describes a hair trimmer blade unit. In this blade unit, the movable blade includes movable blade pieces, each having a blade edge formed on each of its two lateral sides. The blade edge includes a distal linear portion and a basal linear portion. The distal linear portion is inclined so that as the distal end of the corresponding movable blade piece becomes closer, the distance from the adjacent movable blade piece decreases. The basal linear portion is inclined so that as the basal end of the corresponding movable blade piece becomes closer, the distance from the adjacent blade piece decreases.

Hair is received in the gap between the movable blade pieces. The distal linear portions of the movable blade pieces function to reduce the amount of hair that escapes frontward and out of the gap between the movable blade pieces.

### SUMMARY OF THE INVENTION

It is an object of the present invention to provide a hair trimmer blade unit that further reduces the amount of hair escaping frontward and out of a blade unit from the gap between movable blade pieces.

One aspect of the present invention is a hair trimmer blade unit including a comb-shaped stationary blade, which includes a plurality of stationary blade pieces, and a comb-shaped movable blade, which includes a plurality of movable blade pieces. The movable blade is overlapped with the stationary blade, and the movable blade being reciprocative in a direction in which the stationary blade pieces are arranged. Each of the movable blade pieces includes a blade edge on each of its two lateral sides, with the blade edge including a basal blade edge portion and a distal catch portion, which has an end connected to the basal blade edge portion. The basal blade edge portion extends along a first straight line inclined so that as a distal end of the corresponding movable blade piece become closer, a distance from an adjacent one of the movable blade pieces increases. The distal catch portion extends laterally toward the adjacent one of the movable blade pieces from the first straight line. The blade edge of the movable blade piece includes a saw-toothed portion formed so that as the distal end of the corresponding movable blade piece becomes closer, the lateral distance from the adjacent one of the movable blade pieces decreases in a stepped manner.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a side view and 1(b) is a front view showing a preferred embodiment of an electric hair trimmer according to a preferred embodiment of the present invention;

FIG. 2 is a cross-sectional view showing the electric hair trimmer of FIG. 1(a);

FIG. 3 is a perspective view showing a blade block in the electric hair trimmer of FIG. 1(a);

FIG. 4 is an enlarged partial view showing the blade block of FIG. 3; and

FIG. 5 is an enlarged partial view showing a blade block in another example of a hair trimmer.

### DETAILED DESCRIPTION OF THE PREFERRED EMBODIMENTS

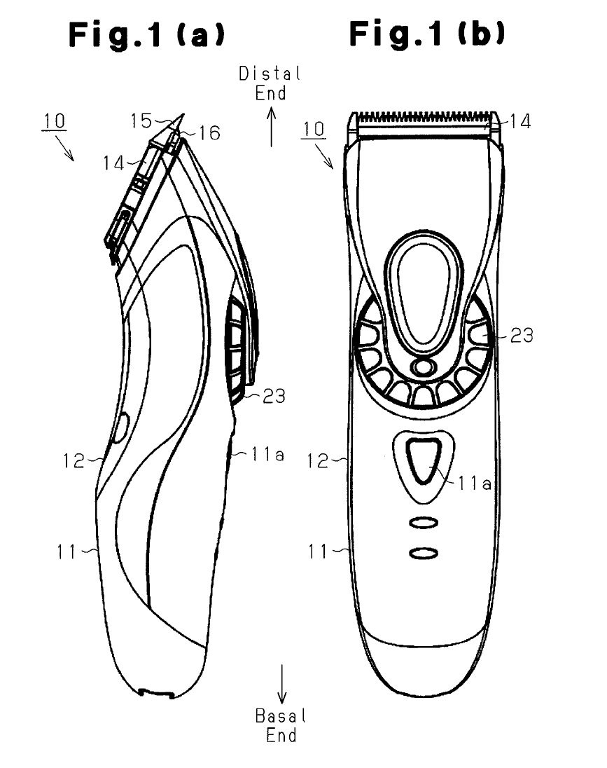

A preferred embodiment of the present invention will now be discussed with reference to FIGS. 1 to 4.

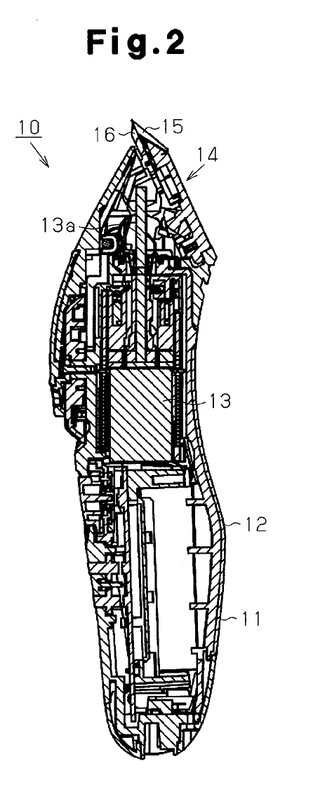

Referring to FIGS. 1(a), 1(b), and 2, an electric hair trimmer 10 includes a blade block 14 and an electric motor 13, which functions as a drive source. A housing 12 houses the electric motor 13. Part of the housing 12 forms a grip 11. The blade block 14 is attached to the distal portion of the housing 12. The electric motor 13 includes a drive shaft 13a, which transmits the drive force of the electric motor 13 to the blade block 14.

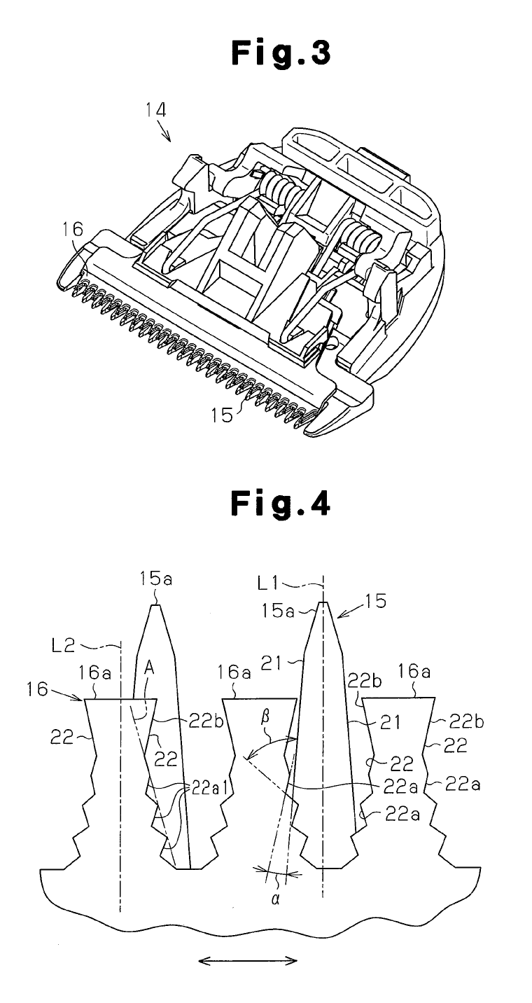

As shown in FIGS. 3 and 4, the blade block 14 includes a comb-shaped stationary blade 15, which includes a plurality of stationary blade pieces 15a, and a comb-shaped movable blade 16, which includes a plurality of movable blade pieces 16a. The drive shaft 13a is connected to the movable blade 16. In this embodiment, the stationary blade 15 and the movable blade 16 serves as a hair trimmer blade unit. The movable blade 16 is overlapped with the stationary blade 15. The distal end of the stationary blade 15 (stationary blade pieces 15a) is extended outward from the distal end of the movable blade 16 (movable blade pieces 16a). The movable blade 16 is reciprocative in the directions in which the movable blade pieces 16a are arranged next to one another, as indicated by the double-headed arrow in FIG. 4.

Operation of an operation switch 11a arranged on the grip 11 activates the electric motor 13. The drive shaft 13a transmits the drive force of the electric motor 13 to the movable blade 16. This linearly reciprocates the movable blade 16 and cuts hair with the stationary blade 15 and movable blade 16.

The stationary blade pieces 15a of the stationary blade 15 will now be discussed. Each stationary blade piece 15a is formed to be symmetric on each side of its center line L1. The stationary blade piece 15a has a blade edge 21 formed on each of its two lateral sides. Each blade edge 21 is formed so that as the distal end of the corresponding stationary blade piece 15a becomes closer, the distance from the adjacent stationary blade piece 15a slightly increases. In other words, each blade edge 21 is inclined so that a line normal to the blade edge 21 is directed diagonally upward.

The movable blade pieces 16a of the movable blade 16 will now be discussed. Each movable blade piece 16a is formed to be symmetric on each side of its center line L2. The movable blade piece 16a has a blade edge 22 formed on each of its two lateral sides. Each blade edge 22 includes a basal blade edge portion 22a and a distal catch portion 22b. The basal blade edge portion 22a extends along a first straight line A inclined so that as the distal end of the corresponding blade edge 22 becomes closer, the distance from the adjacent movable blade piece 16a increases.

The distal catch portion 22b extends from the first straight line A in the lateral direction toward the adjacent movable blade piece 16a at the distal side of the movable blade piece 16a. In one example, the distal catch portion 22b is formed so that as the distal end of the corresponding movable blade piece 16a becomes closer, the distance from the adjacent movable blade piece 16a decreases. In other words, each distal catch portion 22b is inclined so that a line normal to the distal catch portion 22b is directed diagonally downward. The distal catch portions 22b, arranged at the leading end of the movable blade 16, reduce the amount of hair escaping frontward from the movable blade 16.

In the illustrated example, the basal blade edge portion 22a is saw-toothed and includes a plurality of saw teeth. Although not limited in any manner, the basal blade edge portion 22a includes three teeth. Each saw tooth has a tip (peak) extending toward the adjacent movable blade piece 16a. The tips of the saw teeth lie along the first straight line A. Each saw tooth includes a side end 22a1 formed so that as the distal end of the corresponding movable blade piece 16a becomes closer, the lateral distance from the adjacent movable blade piece 16a decreases. Each saw tooth may include a further side end on the other side of the tip, with the further side end formed so that as the distal end of the corresponding movable blade piece 16a becomes closer, the lateral distance from the adjacent movable blade piece 16a increases. The side ends 22a1 of the basal blade edge portion 22a reduce the amount of hair escaping frontward from the movable blade 16 in plural steps.

The basal blade edge portion 22a (saw teeth) and the blade edge 21 of the stationary blade 15 are set so that they trap and cut hair at optimal acute trapping angles α and β.

The movable blade 16 may be moved in the longitudinal direction of the stationary blade pieces 15a by rotating a dial 23 on the housing 12. Such forward or rearward movement of the movable blade 16 relative to the stationary blade 15 adjusts the amount of trimmed hair.

In the electric hair trimmer 10, the electric motor 13 is driven to reciprocate the movable blade 16 relative to the stationary blade 15. In this state, when hair enters the gap between the blade pieces 15a of the stationary blade 15 and the movable blade pieces 16a of the movable blade 16, the blade pieces 15a and 16a trap and cut the hair.

The preferred embodiment has the advantages described below.

(1) Each blade edge 22 of the movable blade pieces 16a includes the basal blade edge portion 22a and the distal catch portion 22b, which has an end connected to the basal blade edge portion 22a. The basal blade edge portion 22a extends along the first straight line A inclined so that as the distal end of the corresponding movable blade 16 becomes closer, the distance from the adjacent movable blade piece 16a increases. The distal catch portion 22b extends laterally from the first straight line A toward the adjacent movable blade piece 16a. The distal catch portion 22b reduces the amount of hair escaping frontward and out of gaps between the distal catch portions 22b and the movable blade pieces 16a.

Further, the basal blade edge portion 22a is saw-toothed and includes a plurality of saw teeth. The side end 22a1 of each saw tooth is formed so that as the distal end of the corresponding movable blade piece 16a becomes closer, the distance from the adjacent movable blade piece 16a decreases. The side ends 22a1 of the basal blade edge portion 22a reduce the amount of hair escaping frontward from the movable blade 16 in plural steps.

In this manner, in the preferred embodiment, the distal catch portions 22b cooperate with the side ends 22a1 to significantly reduce the amount of hair escaping frontward from the gaps between the movable blade pieces 16a.

It should be apparent to those skilled in the art that the present invention may be embodied in many other specific forms without departing from the spirit or scope of the invention. Particularly, it should be understood that the present invention may be embodied in the following forms.

In the above-described embodiment, the saw teeth are formed so that as the distal end of the corresponding movable blade piece 16a becomes closer, the lateral distance from the adjacent movable blade piece 16a decreases. The saw teeth do not have to be formed entirely on the basal blade edge portions 22a of the movable blade pieces 16a. For example, the saw teeth may be formed in part of each blade edge 22. As long as the saw teeth are formed in part of each blade edge 22 of the movable blade pieces 16a, the locations and shapes of the saw teeth may be varied.

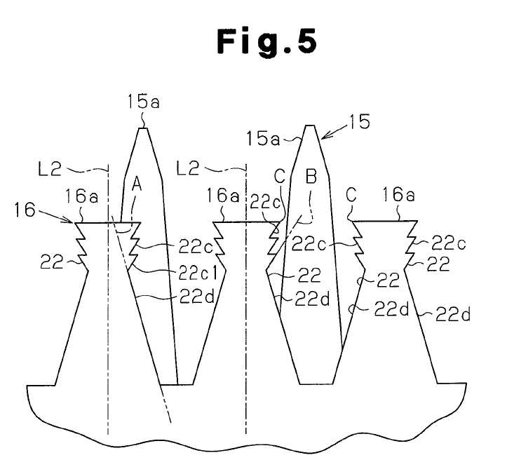

For example, the distal catch portion 22b shown in FIG. 4 may be replaced by a distal catch portion 22c that is shown in FIG. 5. In the example shown in FIG. 5, saw teeth are formed on the entire distal catch portion 22c. Each saw tooth includes a side end 22c1 formed so that as the distal end of the corresponding movable blade piece 16a becomes closer, the distance from the adjacent movable blade piece 16a decreases. Thus, the distal catch portion 22c reduce the amount of hair escaping frontward from the movable blade 16 in plural steps In FIG. 5, the side end 22c1 of the saw tooth located closest to the basal end of each movable blade piece 16a in the distal catch portion 22c (saw teeth) extends along a second straight line B, which is inclined so that as the distal end of the corresponding movable blade piece 16a becomes closer, the distance from the adjacent movable blade piece 16a increases. At the level of the distal end of the movable blade piece 16a, the distal catch portion 22c (saw teeth) includes a distal tip (peak) C located between the second straight line B and the center line L2 of the movable blade piece 16a. Particularly, in the example of FIG. 5, the tips of the saw teeth in the distal catch portion 22c (saw teeth) are generally aligned in the longitudinal direction of the movable blade piece 16a. This widens the gap between adjacent movable blade pieces 16a in comparison with when, for example, the distal tip C lies along the second straight line B. Thus, hair more easily enters the gap between adjacent movable blade pieces 16a (blade edges 22).

FIG. 5 shows a basal blade edge portion 22d that differs from the basal blade edge portion 22a shown in FIG. 4. The basal blade edge portion 22d completely extends along the first straight line A so that as the distal end of the corresponding movable blade piece 16a becomes closer, the distance from the adjacent movable blade piece 16a increases. The basal blade edge portion 22d may, of course, be identical to the basal blade edge portion 22a of the above-described embodiment (refer to FIG. 4). Such structures further reduce the amount of hair escaping out of the gaps in plural steps

In the above-described embodiment, each blade edge 22 of the movable blade pieces 16a in the movable blade 16 may include an inclined raking surface, which forms an acute raking angle with a slide surface (slide direction) of the stationary blade 15. The raking surface (raking angle) functions to prevent the blade edges 22 from pulling hair.

In the above-described embodiment, the side ends 22a1 and 22c1 of the movable blade pieces 16a may be linearly inclined or inwardly curved.

The present examples and embodiments are to be considered as illustrative and not restrictive, and the invention is not to be limited to the details given herein, but may be modified within the scope and equivalence of the appended claims.

What is claimed is:

1. A hair trimmer blade unit comprising:
a comb-shaped stationary blade including a plurality of stationary blade pieces; and
a comb-shaped movable blade including a plurality of movable blade pieces, the movable blade being overlapped with the stationary blade, and the movable blade being reciprocative in a direction in which the stationary blade pieces are arranged;
wherein each of the movable blade pieces includes a blade edge on each of its two lateral sides, with the blade edge including a basal blade edge portion and a distal catch portion, which has an end connected to the basal blade edge portion;
the basal blade edge portion extends along a first straight line inclined so that as a distal end of the corresponding movable blade piece become closer, a distance from an adjacent one of the movable blade pieces increases;
the distal catch portion extends laterally toward the adjacent one of the movable blade pieces from the first straight line; and
the blade edge of the movable blade piece includes a saw-toothed portion formed so that as the distal end of the corresponding movable blade piece becomes closer, the lateral distance from the adjacent one of the movable blade pieces decreases in plural steps.

2. The blade unit according to claim 1, wherein the saw-toothed portion are formed in the basal blade edge portion.

3. The blade unit according to claim 1, wherein the saw-toothed portion are formed in the distal catch portion.

4. The blade unit according to claim 3, wherein:
the saw-toothed portion in the distal catch portion includes a saw tooth located closest to a basal end of the corresponding movable blade piece and having a side end extending along a second straight line, which is inclined so that as the distal end of the corresponding movable blade piece becomes closer, the distance from the adjacent one of the movable blade piece increases; and
the saw teeth includes a distal tip located between the second straight line and a center line of the corresponding movable blade piece at a level of the distal end of the movable blade piece.

5. An electric hair trimmer comprising:
the blade unit according to claim 1; and
a drive source connected to the blade unit to reciprocate the movable blade.
